(19) United States
(12) Patent Application Publication
(10) Pub. No.: US 2013/0105705 A1
(43) Pub. Date: May 2, 2013

(54) ION BEAM EXTRACTION ELECTRODE AND ION SOURCE

(71) Applicant: Nissin Ion Equipment Co., Ltd., Kyoto (JP)

(72) Inventor: Yutaka Inouchi, Kyoto (JP)

(73) Assignee: Nissin Ion Equipment Co., Ltd., Kyoto (JP)

(21) Appl. No.: 13/663,594

(22) Filed: Oct. 30, 2012

(30) Foreign Application Priority Data
Oct. 31, 2011 (JP) 2011-239552

(51) Int. Cl. H01J 1/46; H01J 27/02

(52) U.S. Cl. 250/423 R; 313/296

(57) ABSTRACT

An ion beam extraction electrode includes an electrode frame and a plurality of ion extracting aperture forming members. The plurality of ion extracting aperture forming members are arranged at an interval in a direction. At least one end of each ion extracting aperture forming member is movably supported. The plurality of ion extracting aperture forming members include at least one first ion extracting aperture forming member having a body portion of a substantially bar shape and a first transition portion extending from the body portion. The first transition portion comes in contact with a second ion extracting aperture forming member which is adjacent to the first ion extracting aperture forming member. Further, an ion source includes a plasma vessel having a cathode therein, and at least one sheet of ion beam extraction electrode set forth which is disposed adjacent to the plasma vessel.

### CROSS-REFERENCE TO RELATED APPLICATION(S)

This application claims priority under 35 U.S.C. §119(a) to Japanese Patent Application No. 2011-239552, filed on Oct. 31, 2011, the entire contents of which are hereby incorporated by reference the same as if set forth at length.

### TECHNICAL FIELD

The invention relates to an ion beam extraction electrode used to extract an ion beam from a plasma vessel, and an ion source including the same.

### RELATED ART

There is known an electrode for extracting an ion beam from a plasma vessel, the electrode including a plural of ion extracting apertures of a circular shape or slit shape through which ion passes. A set of plural sheets of electrodes is used in an ion source, and each sheet of electrodes is arranged adjacent to each other in a plasma vessel of the ion source such that the ion extracting apertures formed in the respective electrodes are positioned at the same position in accordance with an extraction direction of the ion beam.

At operation of the ion source, an appropriate voltage is applied to the respective electrodes to extract the ion beam from plasma generated in the plasma vessel. In this instance, the ion extracted from the plasma vessel collides with the electrodes, or heat is transferred to the electrodes from the plasma vessel which is heated by hot temperature, so that each electrode increases at high temperature. For this reason, high-melting point material which can withstand the high temperature is used as a material for the electrode.

However, even though the high-melting point material is used, thermal deformation occurs, although in a slight amount. As the ion source operates long hours, a slight amount of thermal deformation is accumulated, so that its deformation amount is increased. If the amount of thermal deformation of the electrode is increased, the position of the ion extracting aperture formed in the respective electrodes is shifted. Therefore, it is difficult to extract the ion beam of a desired extraction angle or desired current amount.

In order to suppress the thermal deformation, an electrode disclosed in Patent Document 1 is used. Ion beam extracting apertures of a slit shape formed in the electrode are disposed at an interval between a plural of rods which are arranged in an opening formed in an electrode support frame. An end portion of the rod is supported by the electrode support frame such that the end portion is movable along the longitudinal direction. More specifically, a lateral wall of the electrode support frame is provided with an opening through which the rod passes. When the rod passes through the opening, a margin portion (space) is formed between the end portion of the rod in the longitudinal direction and a terminal end portion of the opening.

With the configuration using the rod, when the temperature of the electrode is high, the rod is expanded or contracted in the longitudinal direction thereof by the heat. Since the rod, in which thermal expansion or contraction occurs, is supported by the electrode support frame in the state in which the end portion of the rod in the longitudinal direction not fixed, it can seem that the thermal expansion or contraction does not occur in the rod. As a result, the shape of the ion extracting aperture of the slit shape formed between the plural of rods can be maintained almost constantly. Further, it is possible to prevent the position shift of the ion extracting aperture in the respective electrodes arranged in accordance with the extraction direction of the ion beam.
[Patent Document 1] JP-A-8-148106 (FIGS. 3 and 5 to 7)

### SUMMARY

The ion beam is extracted from the plasma vessel by setting an appropriate potential difference between the respective electrodes. In this instance, an electric field generated between the electrodes may be leaked outward from the electrode via the ion extracting aperture which is formed in the one electrode. A leakage amount of the electric field is associated with an opening area of the ion extracting aperture. As the opening area is large, the leakage amount of the electric field is increased.

Comparing the leakage amount of the electric field from the electrode provided with the ion extracting aperture of the slit shape with the leakage amount of the electric field from the electrode provided with the ion extracting aperture of the circular shape having the same diameter as a distance of a short side of the ion extracting aperture of the slit shape, it is as in the following.

FIGS. 14A and 14B illustrate a plasma vessel 21 provided with an ion extraction opening 22, and an ion source 20 having four sheets of electrodes 23 to 26 for extracting an ion beam. The electrodes 23 to 26 illustrated in FIG. 14A is provided with ion extracting apertures 4 of a slit shape, and the electrodes 23 to 26 illustrated in FIG. 14B is provided with ion extracting apertures 4 of a circular shape. In this instance, taking note of the opening area of the ion extracting aperture 4 in a direction indicated by the arrow A in the drawings, the shape is different, but the size of the ion extracting apertures 4 illustrated in both drawings is substantially equal, so that the leakage amount of the electric field from both electrodes is substantially equal in the direction of the arrow A. Meanwhile, taking note of the opening area of the ion extracting aperture 4 in a direction indicated by the arrow B, the ion beam extracting aperture 4 of the slit shape formed in the electrode is larger than that of the ion beam extracting aperture 4 of the circular shape formed in the electrode. The plasma vessel 21 is provided with a cathode (filament) and a gas inlet port, which are widely known in the related art and are not illustrated.

The shape of the end of the plasma generated in the plasma vessel 21 toward the electrode is associated with an intensity of the electric field generated between an acceleration electrode 23 and an extraction electrode 24. When the ion beam is extracted, the intensity of the electric field generated between the acceleration electrode 23 and the extraction electrode 24 among four sheets of the electrodes is varied depending upon a condition, such as energy of the ion beam to be extracted or an extraction angle of the ion beam. If the intensity of the electric field is weak, the end of the plasma moves toward the side of the acceleration electrode 23, so that the end of the plasma is formed in a convex shape in the direction of the ion beam to be extracted. Meanwhile, if the intensity of the electric field is strong, the end of the plasma moves to the inside of the plasma vessel 21, so that the end of the plasma is formed in a convex shape in a direction opposite to the direction of the ion beam to be extracted,

As described above, in the electrode including an ion extracting aperture 4 of the slit shape as in Patent Document 1, since the leakage amount of the electric field generated between the electrodes is large, the end of the plasma is largely expanded in accordance with the leakage amount. For this reason, in the case where the intensity of the electric field is weak in the electrode including the ion extracting aperture 4 of the slit shape, the end of the plasma crosses the acceleration electrode 23, and then moves to the surface of the extraction electrode 24, thereby causing a short circuit between the electrodes. Therefore, the ion beam may not be extracted. Meanwhile, in the case where the intensity of the electric field is strong, since the amount of the end of the plasma protruding toward the inside of the plasma vessel 21 is increased, the extraction angle of the ion beam to be extracted may be small. If the extraction angle is excessively small, the width of the ion beam extracted from the ion source 20 is smaller than necessary, so that it is concerned that the ion beam is impossibly irradiated onto the whole surface of a target (e.g., silicon waver or glass substrate) having a wanted width.

Therefore, an object of the present invention is to provide an ion beam extraction electrode capable of easily extracting a wanted ion beam from an ion source, and an ion source including the same.

An ion beam extraction electrode of this invention includes an electrode frame and a plurality of ion extracting aperture forming members. The electrode frame has an opening at a center of the electrode frame. The plural of ion extracting aperture forming members are arranged at an interval in a direction. At least one end of each ion extracting aperture forming member is movably supported in a perpendicular direction of the direction. The plural of ion extracting aperture forming members include at least one first ion extracting aperture forming member. The first ion extracting aperture forming member has a body portion of a substantially bar shape and a first transition portion extending from the body portion. The first transition portion comes in contact with a second ion extracting aperture forming member which is adjacent to the first ion extracting aperture forming member.

It is desirable that the second ion extracting aperture forming member has a second concave portion at a position where the first transition portion comes in contact with.

It is desirable that the first ion extracting aperture forming member has a first concave portion which comes in contact with a third transition portion of a third ion extracting aperture forming member. The third ion extracting aperture forming member is adjacent to the first ion extracting aperture forming member. The first transition portion and the first concave portion are disposed in the body portion of the first ion extracting aperture forming member. The first transition portion extends from one end of the body portion in the direction, and the first concave portion is in the other end of the body portion in the direction.

It is desirable that each ion extracting aperture forming member arranged in the opening has the same shape.

It is desirable that the number of the plurality of the ion extracting aperture forming members arranged in the opening is four or more. Except for ion extracting aperture forming members positioned at both ends of the opening in the direction, each ion extracting aperture forming member has the same shape.

It is desirable that the first transition portion and the second concave portion are disposed in the direction in which the plurality of ion extracting aperture forming members are arranged in the opening.

Further, it is desirable that an ion source includes a plasma vessel having a cathode therein, and at least one sheet of ion beam extraction electrode set forth which is disposed adjacent to the plasma vessel.

At least one ion extracting aperture forming member is configured to include the body portion of a substantially bar shape, and the transition portion extending from the body portion, and the transition portion comes in contact with the adjacent ion extracting aperture forming member. Therefore, as compared to the electrode configuration using the rod disclosed in the related art, it is possible to reduce the leakage amount of an electric field emerged from the ion extracting aperture. For this reason, the wanted ion beam can be easily extracted from the ion source, as compared to the configuration of the related art.

### BRIEF DESCRIPTION OF THE DRAWINGS

FIG. 1 is a diagram illustrating one example of an ion beam extraction electrode for use in the present invention.

FIG. 2 is a diagram illustrating a state in which a cover is removed from the ion beam extraction electrode in FIG. 1.

FIGS. 3A to 3C are perspective views illustrating an ion extracting aperture forming member in FIG. 1, in which FIG. 3A is a diagram of the ion extracting aperture forming member having a body portion of a circular cross section when seen from a plane YZ, FIG. 3B is a diagram of the ion extracting aperture forming member having a body portion of a rectangular cross section when seen from a plane YZ, and FIG. 3C is a diagram of the ion extracting aperture forming member having a body portion of a convex cross section when seen from a plane YZ.

FIGS. 4A to 4C are diagrams illustrating a support structure of both ends of the ion extracting aperture forming member in FIG. 1 in a direction X, in which FIG. 4A is a perspective view illustrating a shape of both ends of the ion extracting aperture forming member, FIG. 4B is a cross-sectional view taken along the line V1 in FIG. 4A, and FIG. 4C is a cross-sectional view taken along the line W1 in FIG. 4A.

FIG. 5 is a diagram illustrating a first modified embodiment of the ion extracting aperture forming member for use in the present invention.

FIG. 6 is a diagram illustrating a second modified embodiment of the ion extracting aperture forming member for use in the present invention.

FIG. 7 is a diagram illustrating a third modified embodiment of the ion extracting aperture forming member for use in the present invention.

FIG. 8 is a diagram illustrating a fourth modified embodiment of the ion extracting aperture forming member for use in the present invention.

FIGS. 9A to 9C are perspective views illustrating the ion extracting aperture forming member in FIGS. 6 to 8, in which FIG. 9A corresponds to the second modified embodiment in FIG. 6, FIG. 9B corresponds to the third modified embodiment in FIG. 7, and FIG. 9C corresponds to the fourth modified embodiment in FIG. 8.

FIG. 10 is a diagram illustrating a fifth modified embodiment of the ion extracting aperture forming member for use in the present invention.

FIG. 11 is a diagram illustrating a sixth modified embodiment of the ion extracting aperture forming member for use in the present invention.

FIGS. 12A and 12B are enlarged perspective views illustrating a portion of the ion extracting aperture forming member, in which FIG. 12A corresponds to the fifth modified embodiment in FIG. 10 and FIG. 12B corresponds to the sixth modified embodiment in FIG. 11.

FIGS. 13A to 13C are diagrams illustrating a modified embodiment of a support structure for both ends of the ion extracting aperture forming member in FIGS. 4A to 4C in a direction X, in which FIG. 13A is a perspective illustrating both ends of the ion extracting aperture forming member, FIG. 13B is a cross-sectional view taken along the line V2 in FIG. 13A, and FIG. 13C is a cross-sectional view taken along the W2 in FIG. 13A.

FIGS. 14A and 14B are diagrams illustrating an example of an ion source used in the art, in which FIG. 14A illustrates an example in which an ion beam extraction electrode is provided with an ion extracting aperture of a slit shape, and FIG. 14B illustrates an example in which an ion beam extraction electrode is provided with an ion extracting aperture of a circular shape.

### DETAILED DESCRIPTION

In the following embodiments, each of axes X, Y, and Z illustrated in the respective drawings is perpendicular to each other.

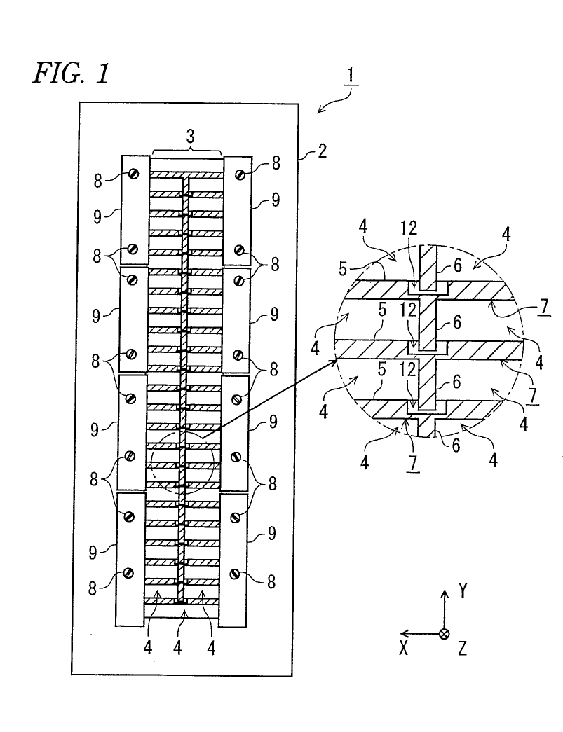

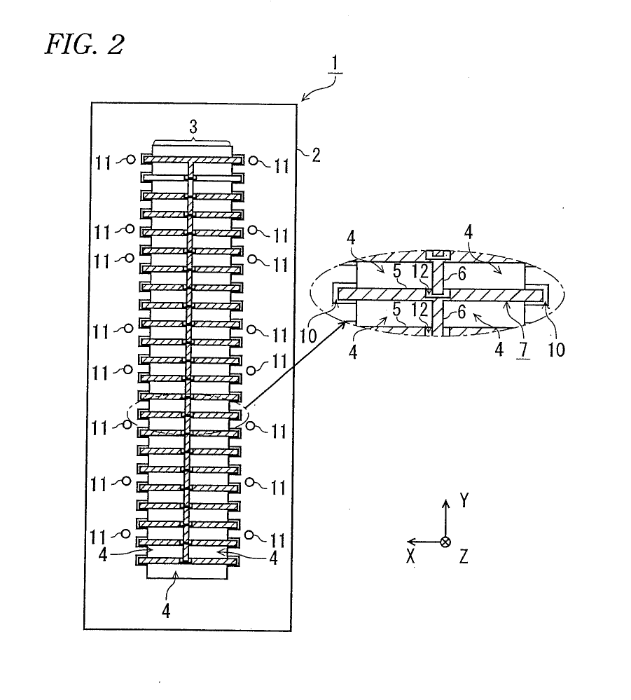

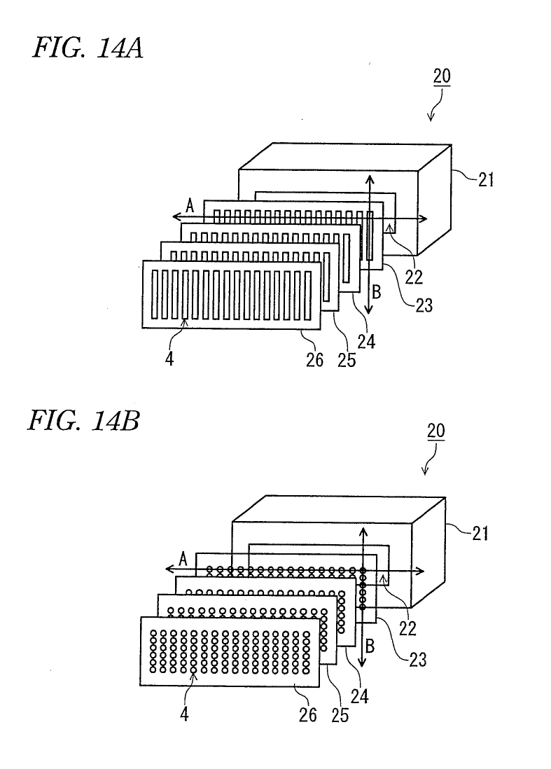

FIGS. 1 and 2 illustrate an example of an ion beam extraction electrode 1 for use in the present invention. The ion beam extraction electrode 1 corresponds to one sheet of electrodes 23 to 26 configuring an ion source 20 illustrated in FIG. 14A.

The configuration of the electrode will now be described in concrete with reference to FIGS. 1 and 2. The ion beam extraction electrode 1 of the present invention includes an electrode frame 2 provided with an opening 3 at a center thereof. The opening 3 penetrates the electrode frame 2 in a direction X illustrated in the drawing, and a plurality of ion extracting aperture forming members 7 are arranged in the opening 3 at a interval in a direction Y.

In the direction Y, an ion extracting aperture 4 is formed between the respective ion extracting aperture forming members 7 and between the electrode frame 2 and the ion extracting aperture forming member 7 disposed at both ends. Extraction of an ion beam is performed through the apertures.

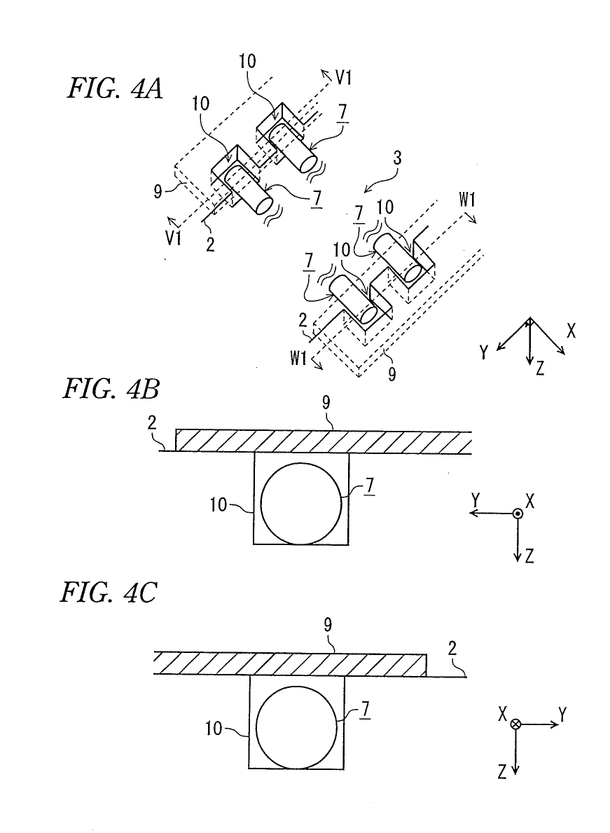

As illustrated in FIG. 4A, the electrode frame 2 is provided with a support portion 10 which is recessed in a direction Z from a surface of the electrode frame. Both ends (end in a direction along the direction X) of the ion extracting aperture forming member 7 are supported by the support portion 10. Also, in the direction along the direction X, a gap is formed between at least one of both ends of the ion extracting aperture forming member 7 and the support portion 10. With the above configuration, as disclosed in Patent Document 1, the ion extracting aperture forming member 7 can be allowed for expansion or retraction in the direction along the direction X due to thermal deformation.

In this embodiment, in the direction opposite to the direction Z, a cover 9 is installed to cover the end of the ion extracting aperture forming member 7 supported by the support portion 10 (see FIG. 1). The cover 9 is installed to prevent the ion extracting aperture forming member 7 from coming out in the side opposite to the direction Z. As a screw 8 is fastened to a threaded hole 11 formed in the electrode frame 2 through a through-hole (not illustrated) in the cover 9, the cover 9 is attached to the electrode frame 2. By use of the configuration, it is possible to easily replace the ion extracting aperture forming member 7 (corresponding to the rod disclosed in Patent Document 1) which is deformed by heat, as compared to the configuration disclosed in Patent Document 1.

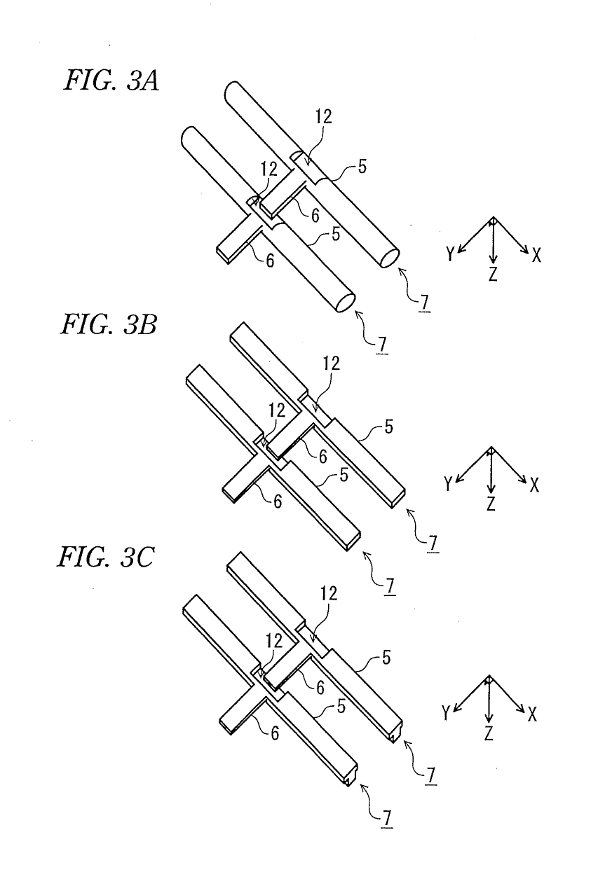

FIGS. 3A to 3C are perspective views the ion extracting aperture forming member 7 in FIGS. 1 and 2. The ion extracting aperture forming member 7 includes a substantially bar-shaped body portion 5 formed in the direction X, and a transition portion 6 extending from the body portion 5. Also, the transition portion 6 comes in physically and electrically contact with the ion extracting aperture forming member 7 which is disposed adjacent to the transition portion. The contact portion is provided with a concave portion 12 for receiving and supporting the transition portion 6. Since the above configuration is employed, a leakage amount of an electric field emerged from the ion extracting aperture can be decreased, as compared to the configuration of the electrode using the rod which is disclosed in Patent Document 1. For this reason, the extraction of the wanted ion beam from the ion source can be easily performed.

Also, in the direction X, it is preferable that a lateral wall of the concave portion 12 does not come in contact with a front end portion of the transition portion 6. Specifically, a gap is formed between the lateral wall of the concave portion 12 and the transition 6. By use of the above configuration, the transition portion 12 is allowed for expansion or contraction due to the heat.

The ion extracting aperture forming member 7 in a plane YZ may be formed in a circular shape, as illustrated in FIG. 3A, or in a rectangular shape, as illustrated in FIG. 3B. Also, as illustrated in FIG. 3C, the ion extracting aperture forming member 7 may be formed in a convex shape. It is possible to determine a shape capable of easily controlling the shape of the ion beam at extraction or extracting a current amount of the ion beam to be extracted.

FIG. 4A illustrates a support structure of both ends of the ion extracting aperture forming member 7 in FIG. 2 in the direction X. Also, FIGS. 4B and 4C illustrate a cross-sectional view taken along the line V1 and a cross-sectional view taken along the line W1 in FIG. 4A, respectively. As illustrated in FIG. 4A, both ends of the ion extracting aperture forming member 7 does not come in contact with the lateral wall of the support portion 10, in the direction along the direction X. That is, a gap is formed between both ends of the ion extracting aperture forming member 7 and the lateral wall of the support portion 10. By employing the above configuration, the ion extracting aperture forming member 7 can be allowed for expansion or retraction in the direction X. Meanwhile, the present invention is not limited to the illustrated configuration, and, as described above, it is preferable that a gap is formed between one end of the ion extracting aperture forming member 7 and the support portion 10. That is, any one of both ends of the ion extracting aperture forming member 7 may come in contact with the lateral wall of the support portion 10 in the direction along the direction X.

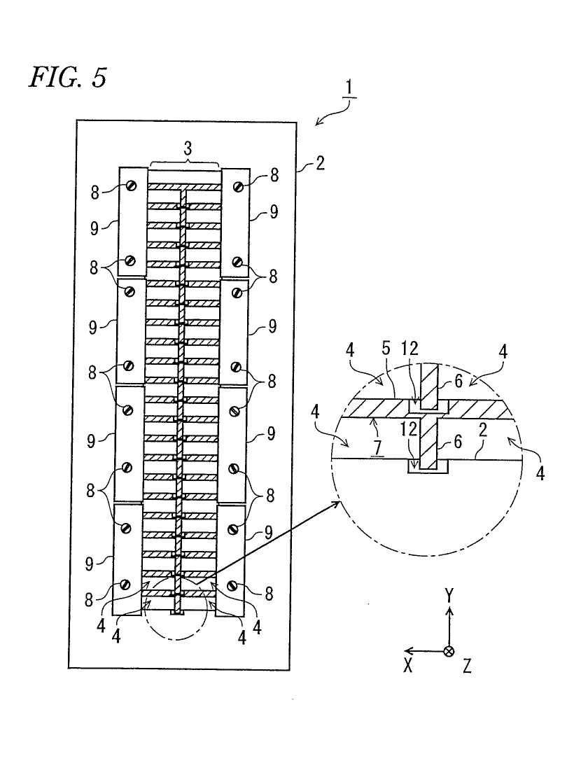

The configuration of the ion extracting aperture forming member 7 of the present invention is not limited to the above description. FIG. 5 illustrates a first modified embodiment of the ion extracting aperture forming member 7.

In the plurality of ion extracting aperture forming members 7 illustrated in FIGS. 1 and 2, the number of the ion extracting aperture forming members 7 arranged in the opening 3 is four or more, and the shape of the ion extracting aperture forming members 7 disposed at both ends of the opening 3 formed in the electrode frame 2 is different from that of the other ion extracting aperture forming members 7 disposed at other locations in the direction along the direction Y. By contrast, the shape of all the ion extracting aperture forming members 7 in the first modified embodiment illustrated in FIG. 5 is identical to each other. By employing the above configuration, since the member can be used in common, it is possible to reduce a manufacturing cost of the ion extracting aperture forming member 7. Meanwhile, in this instance, the transition portion 6 of the ion extracting aperture forming member 7 illustrated on the lowest portion of the drawing paper is configured to be supported by the concave portion 12 formed in the electrode frame 2.

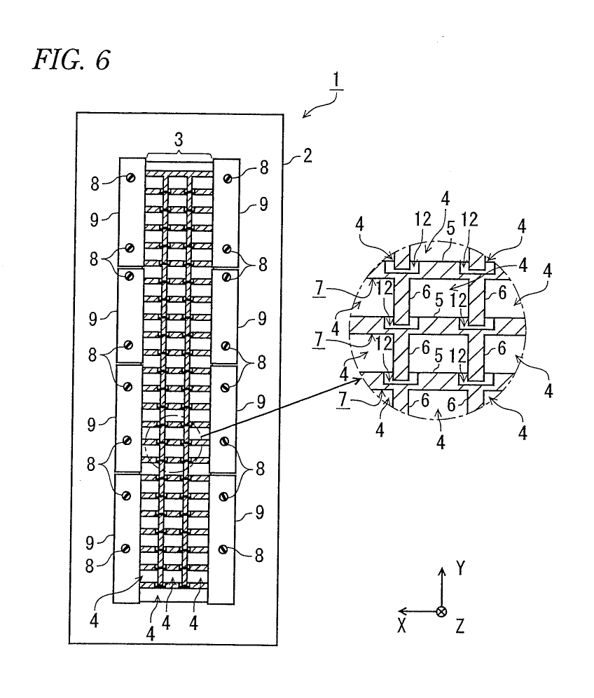

FIG. 6 is a diagram illustrating a second modified embodiment of the ion extracting aperture forming member 7. As illustrated in FIG. 6, the number of the transition portions of the respective ion extracting aperture forming members 7 is two. Also, the present invention is not limited thereto, and two or more may be provided. For example, the number may be appropriately selected from the relationship between the leakage amount of the electric field from the ion extracting aperture 4 and the current amount of the ion beam to be extracted.

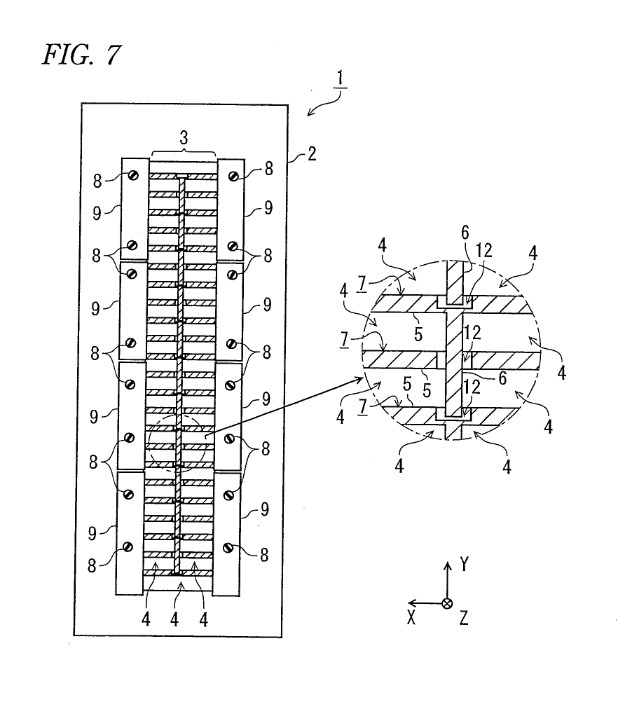

FIG. 7 is a diagram illustrating a third modified embodiment of the ion extracting aperture forming member for use in the present invention. As illustrated in the modified embodiment, the ion extracting aperture forming member 7 having the transition portion 6 and the ion extracting aperture forming member 7 having no transition portion 6 may be installed. In the example of FIG. 7, the transition portion 6 extending from the body portion 5 of one ion extracting aperture forming member 7 is brought in contact with the concave portion 12 of the ion extracting aperture forming member 7, which is disposed adjacent to the transition, to be supported by the ion extracting aperture forming member 7. A front end of the transition portion 6 extends to the concave portion 12 of the ion extracting aperture forming member 7 disposed at two neighbors beyond the concave portion 12.

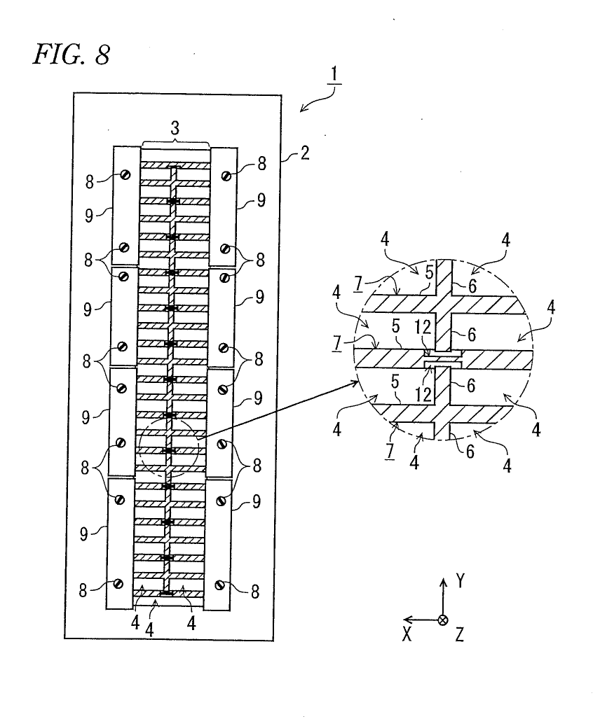

FIG. 8 is a diagram illustrating a fourth modified embodiment of the ion extracting aperture forming member. As illustrated in the drawing, the ion extracting aperture forming member 7 may be used, in which the transition portion 6 is installed at both sides of the body portion 5 along the direction Y.

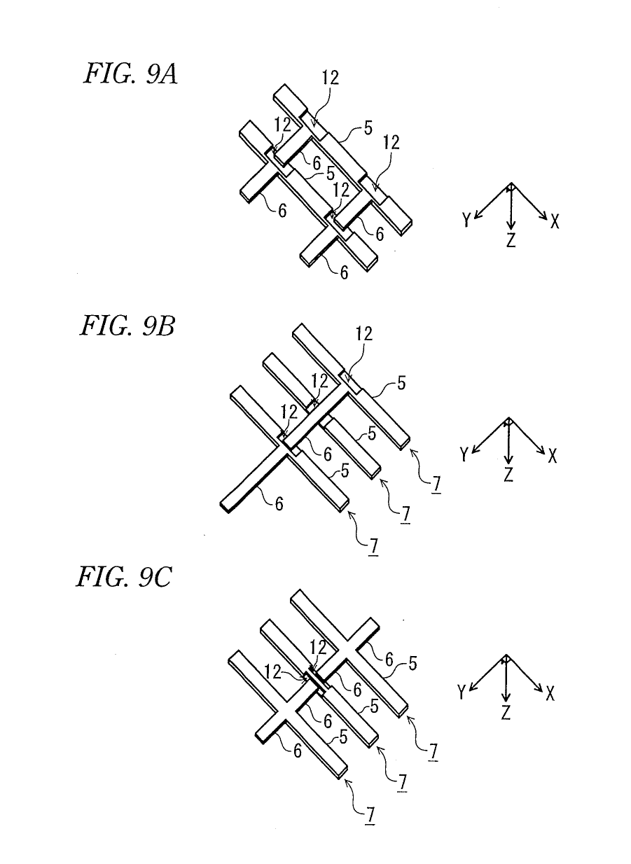

FIGS. 9A to 9c are perspective views illustrating the ion extracting aperture forming member 7 in FIGS. 6 to 8. FIG. 9A corresponds to FIG. 6, and two transition portions 6 are extended from the body portion 5 of the ion extracting aperture forming member 7, and are supported by the concave portion 12 of the adjacent ion extracting aperture forming member 7. FIG. 9B corresponds to FIG. 7, and a transition portion 6 of one ion extracting aperture forming member 7 is supported by the concave portions 12 of two adjacent ion extracting aperture forming members 7 via the concave portion 12 of the adjacent ion extracting aperture forming member 7. FIG. 9C corresponds to FIG. 8, and the body portion 5 configuring one ion extracting aperture forming member 7 is provided with the transition portion 6 at both sides thereof.

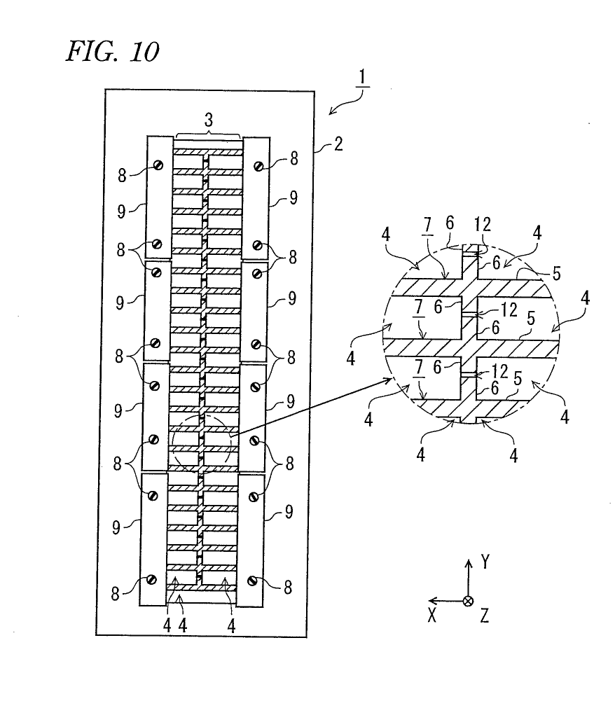

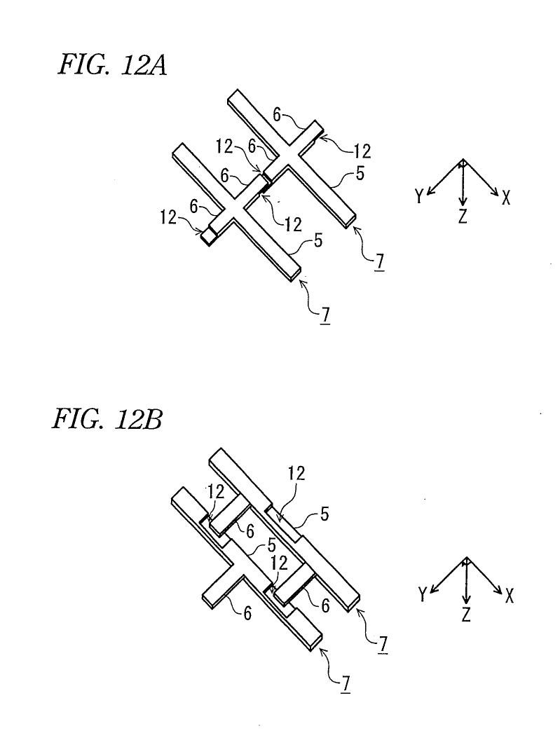

FIG. 10 is a diagram illustrating a fifth modified embodiment of the ion extracting aperture forming member 7. In this example, the transition portion 6 extending from the body portion 5 of the ion extracting aperture forming member 7 is provided at a front end thereof with the concave portion 12. The detailed configuration will be now described with reference to FIG. 12A which will be described later.

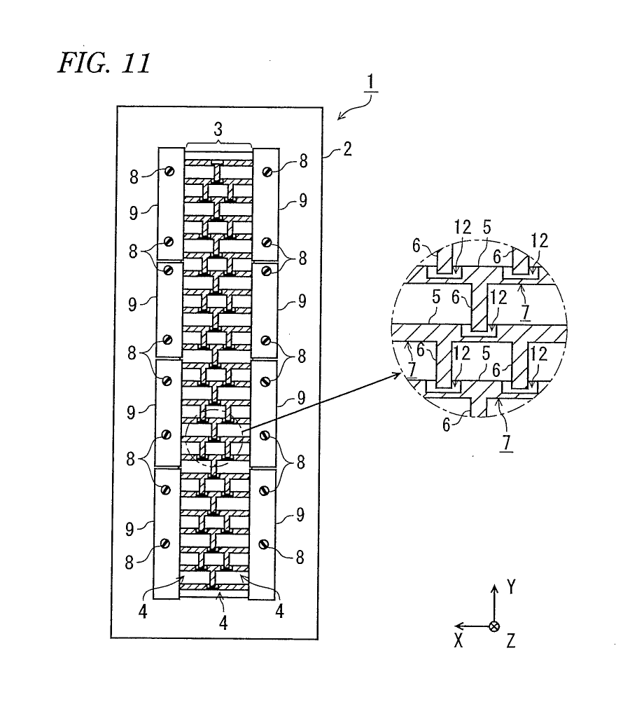

FIG. 11 illustrates the state in which the transition portions 6 of the ion extracting aperture forming members 7 arranged in the direction Y are alternatively formed in a different shape for every ion extracting aperture forming member 7. Such an ion extracting aperture forming member 7 may be used.

FIGS. 12A and 12B are perspective views of the ion extracting aperture forming member 7 illustrated in FIGS. 10 and 11. FIG. 12A corresponds to FIG. 10, and the concave portions 12 formed at the front end portion of the transition portions 6 of the adjacent ion extracting aperture forming member 7 are overlapped with each other. Also, FIG. 12B corresponds to FIG. 11, and the transition portions 6 of the adjacent ion extracting aperture forming members 7 are formed in a different shape.

In the embodiments heretofore, the extending direction of the transition portion 6 is the direction Y, but the present invention is not limited thereto. The transition portion may be formed to extend in a direction at a determined angle to the direction Y.

Also, the transition portions 6 of the plurality of ion extracting aperture forming members 7 are not necessarily disposed on a straight line, but the position in which the transition portion 6 is provided in the direction X may be changed in the respective ion extracting aperture forming members 7.

It is not necessary to form the transition portion 6 on all ion extracting aperture forming members 7. For example, the transition portions 6 may be formed on several ion extracting aperture forming members 7 disposed near the center of the opening 3.

As the configuration of the ion source, the ion source including the ion beam extraction electrode 1 described above is sufficient. For example, in the ion source 20 including the configuration of the related art illustrated in FIG. 14A, the ion beam extraction electrode 1 may be respectively used for the plurality of electrodes 23 to 26. In the case where the ion beam extraction electrode 1 of the present invention is used for an electrode, in addition to the acceleration electrode 23, there is a possibility in that ion extracted from the plasma using the acceleration electrode 23 collides against the transition portion 6 of the electrodes 24 to 26, after the acceleration electrode 23. If the ion collides, secondary electrons are emitted from the electrode, and thus discharge may be caused by the secondary electrons. For this reason, in order to suppress occurrence of the discharge, the ion beam extraction electrode 1 of the present invention is considered to be used for the acceleration electrode 23 only. Also, the ion source including four sheets of electrodes is not necessary as described above, and an ion source including one sheet of such an electrode is sufficient.

The configuration of the body portion 5 is a substantially bar type, but it is not necessary to be straight like the bar. That is, even a slightly bent shape is good.

In the embodiments heretofore, the configuration in which the concave portion 12 is brought in contact with the transition portion 6 has been described. But, the concave portion 12 may not be formed, and the transition portion may be directly laid on the adjacent ion extracting aperture forming member 7. In this instance, since the posture of the ion extracting aperture forming member 7 is not stable, it is considered that the front end of the transition portion 6 is formed in a substantially U-shape which is hooked to the body portion 5 of the adjacent ion extracting aperture forming member 7.

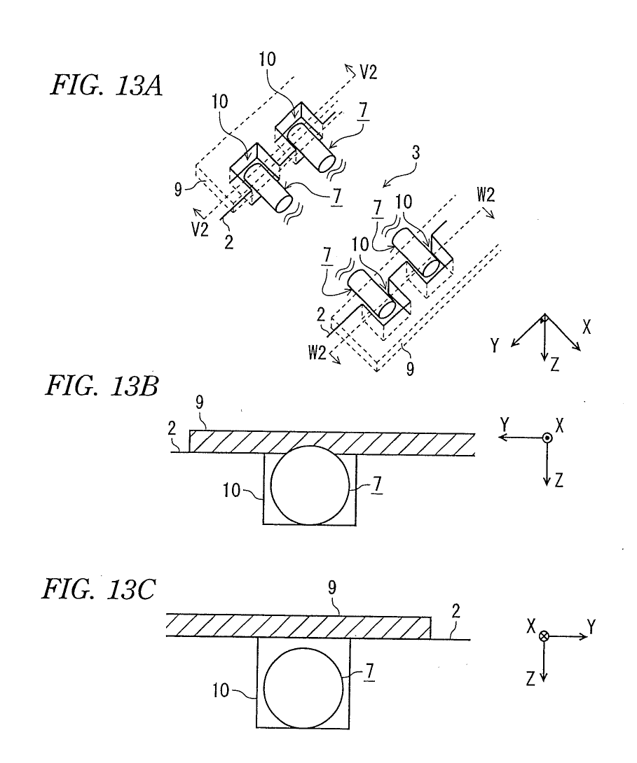

FIG. 13A is a diagram illustrating a modified embodiment of the support structure for both ends of the ion extracting aperture forming member 7 in FIG. 4A in the direction X. FIGS. 13B and 13c are cross-sectional views taken along the lines V2 and W2 in FIG. 13A, respectively.

As illustrated in FIG. 13B, a size of the end of the ion extracting aperture forming member 7, which is positioned at the side opposite to the direction X, in the direction Z is larger than that of the support portion 10 in the same direction. For this reason, a portion of the ion extracting aperture forming member 7 protrudes from the support portion 10. Also, a portion of the cover covering the upper portion of the support portion 10 is formed along the shape of the ion extracting aperture forming member 7 protruding from the support portion. As the cover 9 is attached to the electrode frame 2, the ion extracting aperture forming member 7 is pushed against the support portion 10 in the direction Z. Therefore, the end of the ion extracting aperture forming member 7 at the side opposite to the direction X is supported by the support portion 10 in the fixed state. Meanwhile, as illustrated in FIG. 13C, the end of the ion extracting aperture forming member 7 is movably supported by the support portion 10, similar to the embodiment illustrated in FIG. 4C.

Instead of the configuration in which both ends of the ion extracting aperture forming member 7 are movably supported, other configuration is available, in which one end of the ion extracting aperture forming member 7 is fixed, as described in the embodiment, and the other end is movable supported. Even using the above configuration, since one end is movably supported, the ion extracting aperture forming member 7 is allowed for the thermal expansion or contraction.

While the present invention has been described with respect to the specific embodiments, it will be apparent to those skilled in the art that various changes and modifications may be made without departing from the spirit and scope of the invention defined in the following claims.

What is claimed is:

1. An ion beam extraction electrode comprising:
an electrode frame that has an opening at a center of the electrode frame; and
a plurality of ion extracting aperture forming members that are arranged at an interval in a direction, at least one end of each ion extracting aperture forming member being movably supported in a perpendicular direction of the direction,
wherein the plurality of ion extracting aperture forming members include at least one first ion extracting aperture forming member,
the first ion extracting aperture forming member has a body portion of a substantially bar shape and a first transition portion extending from the body portion, and
the first transition portion comes in contact with a second ion extracting aperture forming member which is adjacent to the first ion extracting aperture forming member.

2. The ion beam extraction electrode according to claim 1,
wherein the second ion extracting aperture forming member has a second concave portion at a position where the first transition portion comes in contact with.

3. The ion beam extraction electrode according to claim 2,
wherein the first ion extracting aperture forming member has a first concave portion which comes in contact with a third transition portion of a third ion extracting aperture forming member, the third ion extracting aperture forming member being adjacent to the first ion extracting aperture forming member,
the first transition portion and the first concave portion are disposed in the body portion of the first ion extracting aperture forming member,
the first transition portion extends from one end of the body portion in the direction, and
the first concave portion is in the other end of the body portion in the direction.

4. The ion beam extraction electrode according to claim 1,
wherein each ion extracting aperture forming member arranged in the opening has the same shape.

5. The ion beam extraction electrode according to claim 2,
wherein each ion extracting aperture forming member arranged in the opening has the same shape.

6. The ion beam extraction electrode according to claim 3,
wherein each ion extracting aperture forming member arranged in the opening has the same shape.

7. The ion beam extraction electrode according to claim 1,
wherein the number of the plurality of the ion extracting aperture forming members arranged in the opening is four or more, and
except for ion extracting aperture forming members positioned at both ends of the opening in the direction, each ion extracting aperture forming member has the same shape.

8. The ion beam extraction electrode according to claim 2,
wherein the number of the plurality of the ion extracting aperture forming members arranged in the opening is four or more, and
except for ion extracting aperture forming members positioned at both ends of the opening in the direction, each ion extracting aperture forming member has the same shape.

9. The ion beam extraction electrode according to claim 3,
wherein the number of the plurality of the ion extracting aperture forming members arranged in the opening is four or more, and
except for ion extracting aperture forming members positioned at both ends of the opening in the direction, each ion extracting aperture forming member has the same shape.

10. The ion beam extraction electrode according to claim 2,
wherein the first transition portion and the second concave portion are disposed in the direction in which the plurality of ion extracting aperture forming members are arranged in the opening.

11. The ion beam extraction electrode according to claim 3,
wherein the first transition portion and the second concave portion are disposed in the direction in which the plurality of ion extracting aperture forming members are arranged in the opening.

12. An ion source comprising a plasma vessel including a cathode therein, and at least one sheet of ion beam extraction electrode set forth in claim 1 which is disposed adjacent to the plasma vessel.

13. An ion source comprising a plasma vessel including a cathode therein, and at least one sheet of ion beam extraction electrode set forth in claim 2 which is disposed adjacent to the plasma vessel.

14. An ion source comprising a plasma vessel including a cathode therein, and at least one sheet of ion beam extraction electrode set forth in claim 3 which is disposed adjacent to the plasma vessel.

15. An ion source comprising a plasma vessel including a cathode therein, and at least one sheet of ion beam extraction electrode set forth in claim 4 which is disposed adjacent to the plasma vessel.

16. An ion source comprising a plasma vessel including a cathode therein, and at least one sheet of ion beam extraction electrode set forth in claim 5 which is disposed adjacent to the plasma vessel.

17. An ion source comprising a plasma vessel including a cathode therein, and at least one sheet of ion beam extraction electrode set forth in claim 6 which is disposed adjacent to the plasma vessel.

18. An ion source comprising a plasma vessel including a cathode therein, and at least one sheet of ion beam extraction electrode set forth in claim 7 which is disposed adjacent to the plasma vessel.

19. An ion source comprising a plasma vessel including a cathode therein, and at least one sheet of ion beam extraction electrode set forth in claim 8 which is disposed adjacent to the plasma vessel.

20. An ion source comprising a plasma vessel including a cathode therein, and at least one sheet of ion beam extraction electrode set forth in claim 9 which is disposed adjacent to the plasma vessel.

21. An ion source comprising a plasma vessel including a cathode therein, and at least one sheet of ion beam extraction electrode set forth in claim 10 which is disposed adjacent to the plasma vessel.

22. An ion source comprising a plasma vessel including a cathode therein, and at least one sheet of ion beam extraction electrode set forth in claim 11 which is disposed adjacent to the plasma vessel.
